(19) United States
(12) Patent Application Publication
(10) Pub. No.: US 2019/0128210 A1
(43) Pub. Date: May 2, 2019

(54) Cylinder Structure of Diesel Engine

(71) Applicants: Hyundai Motor Company, Seoul (KR); Kia Motors Corporation, Seoul (KR)

(72) Inventors: Yoonghwa Park, Seongnam-si (KR); Byung Ok Park, Hwaseong-si (KR); Youngjun Roh, Anyang-si (KR); In Cheol Cheong, Gwangmyeong-si (KR); Dong Keun Yu, Suwon-si (KR); Yonggyu Lee, Suwon-si (KR); Ki Wook Byeon, Seoul (KR)

(21) Appl. No.: 15/823,207

(22) Filed: Nov. 27, 2017

(30) Foreign Application Priority Data
Oct. 27, 2017 (KR) 10-2017-0141044

(51) Int. Cl. F02F 1/42

(52) U.S. Cl. CPC F02F 1/4214; F02F 2001/241; F02F 1/4264; F02F 1/4235

(57) ABSTRACT

A cylinder structure of a diesel engine in which diesel fuel is ignited by a self-ignition manner includes a cylinder including a cylinder body in which a combustion chamber is formed and a cylinder head covering an upper portion of the cylinder body, at least one intake valve included in an intake port formed in the cylinder head, at least one exhaust valve included in an exhaust port formed in the cylinder head, and a diesel injector mounted at the center of the cylinder head and injecting diesel fuel. A lower surface of the cylinder head may be formed in a pent roof shape.

### CROSS-REFERENCE TO RELATED APPLICATIONS

This application claims priority to Korean Patent Application No. 10-2017-0141044, filed in the Korean Intellectual Property Office on Oct. 27, 2017, which application is hereby incorporated herein by reference.

### TECHNICAL FIELD

The present invention relates to a cylinder structure of a diesel engine.

### BACKGROUND

An engine is generally classified into a gasoline engine and a diesel engine.

The gasoline engine, which is an internal combustion engine using gasoline as fuel, sucks air and gasoline fuel into a cylinder and ignites the compressed mixture gas for combustion. On the other hand, the diesel engine, which is an internal combustion engine using diesel as fuel, sucks air into a cylinder by a piston, compresses the air to a high pressure, and then injects the fuel under high temperature and high pressure and combusts the fuel by self-ignition.

A lower surface of a cylinder head of the cylinder applied to the diesel engine according to the related art is formed in a flat surface. As such, in the case in which the lower surface of the cylinder head is formed in the flat surface, since diameters of an intake valve and an exhaust valve may not be manufactured to be large, an amount of air flowing into the cylinder is limited. Therefore, it is difficult to maximize performance of the diesel engine.

Further, in the case in which the lower surface of the cylinder head is formed in the flat surface, only a flow in a swirl direction is generated inside the cylinder by the air introduced through an intake port, thereby limiting the performance of the engine.

The above information disclosed in this Background section is only for enhancement of understanding of the background of the invention and therefore it may contain information that does not form the prior art that is already known in this country to a person of ordinary skill in the art.

The above information disclosed in this Background section is only for enhancement of understanding of the background of the invention and therefore it may contain information that does not form the prior art that is already known in this country to a person of ordinary skill in the art.

### SUMMARY

The present invention has been made in an effort to provide a cylinder structure of a diesel engine having advantages of increasing an amount of air introduced into a cylinder to improve performance of the engine by increasing diameters of an intake valve and an exhaust valve in the diesel engine.

Further, the present invention has been made in an effort to provide a cylinder structure of a diesel engine having advantages of improving performance of the engine by generating a flow in a swirl direction and a flow in a tumble direction in a cylinder by air introduced through an intake port.

An exemplary embodiment of the present invention provides a cylinder structure of a diesel engine in which diesel fuel is ignited by a self-ignition manner including a cylinder including a cylinder body in which a combustion chamber is formed and a cylinder head covering an upper portion of the cylinder body, wherein the combustion chamber is formed by an upper portion of a piston and a lower portion of the cylinder head, and an intake valve and an exhaust valve are provided to be inclined at a predetermined angle in a radial direction outwardly from the center of the cylinder head, such that the intake valve and the exhaust valve form a narrow angle with each other.

The intake valve may be included in an intake port formed in the cylinder head, the exhaust valve may be included in an exhaust port formed in the cylinder head, and a diesel injector that injects diesel fuel may be provided to the center of the cylinder head.

A lower surface of the cylinder head may be formed in a pent roof shape.

The lower surface of the cylinder head may include a pair of inclined portions in which the intake port and the exhaust port are each formed; and a corner portion which is in contact with the pair of inclined portions, and the pent roof shape may be formed by the inclined portions and the corner portion that cooperate with each other.

The diesel injector may be installed at the center of the corner portion.

The intake port and the exhaust port may be each formed in the inclined portion.

According to an embodiment of the present invention, in the cylinder structure of the diesel engine, since the diameter of the intake valve may be formed to be large by forming the cylinder head of the diesel engine in a pent root shape, the amount of air introduced into the cylinder may be increased, thereby maximizing performance of the engine.

Further, since the flow in the swirl direction and the flow in tumble direction may be generated in the cylinder by forming the cylinder head of the diesel engine in the pent roof shape, performance of the engine may be improved.

### BRIEF DESCRIPTION OF THE DRAWINGS

The drawings are to reference in describing exemplary embodiment of the present invention, and the technical scope of the present invention is not interpreted to be limited to the accompanying drawings.

FIG. 1 is a conceptual view illustrating a configuration of a diesel engine according to an exemplary embodiment of the present invention;

FIG. 2 is a perspective view illustrating a cylinder of the diesel engine according to an exemplary embodiment of the present invention;

FIG. 3 is a partial cross-sectional view illustrating the cylinder of the diesel engine according to an exemplary embodiment of the present invention;

FIG. 4 is a side view illustrating a configuration of the cylinder according to an exemplary embodiment of the present invention;

FIG. 5 is a plan view illustrating a configuration of the cylinder according to an exemplary embodiment of the present invention; and

FIGS. 6 to 9 are views illustrating an operation of a diesel combustion engine according to an exemplary embodiment of the present invention.

### DETAILED DESCRIPTION OF ILLUSTRATIVE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

The drawings and description are to be regarded as illustrative in nature and not restrictive, and like reference numerals designate like elements throughout the specification.

Since sizes and thicknesses of the respective components shown in the drawings are arbitrarily shown for the convenience of explanation, the present invention is not necessarily limited to those shown in the drawings, and thicknesses of several parts and regions are exaggerated for clarity.

Hereinafter, a cylinder structure of a diesel engine according to an exemplary embodiment of the present invention will be described in detail with reference to the accompanying drawings.

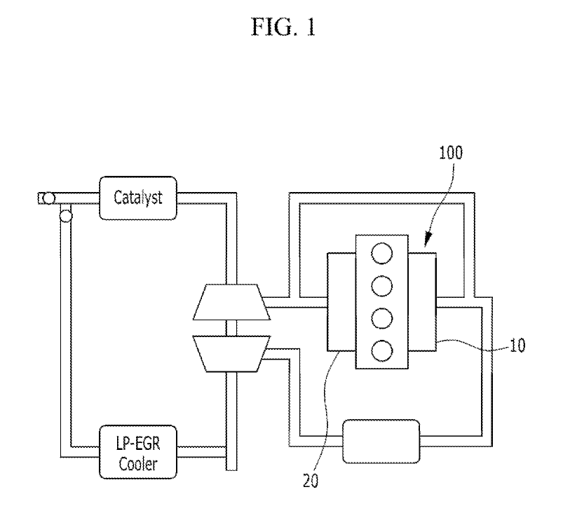

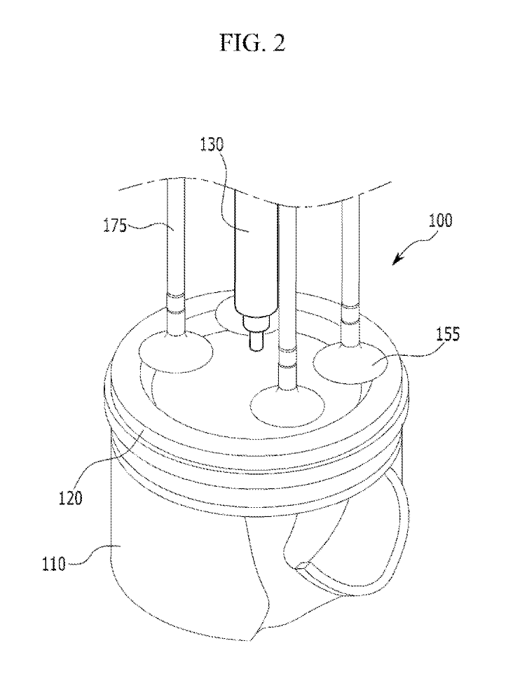

FIG. 1 is a conceptual view illustrating a configuration of a diesel engine according to an exemplary embodiment of the present invention. FIG. 2 is a perspective view illustrating a cylinder of the diesel engine according to an exemplary embodiment of the present invention.

As illustrated in FIGS. 1 and 2, an engine system to which a cylinder of a diesel engine according to an exemplary embodiment of the present invention is applied includes a plurality of cylinders 100 that generate power by combustion of diesel fuel.

The air introduced through an intake line is supplied to the cylinders 100 through an intake manifold 10, and exhaust gas generated from the cylinders 100 is discharged to the outside through an exhaust manifold 20 and an exhaust line.

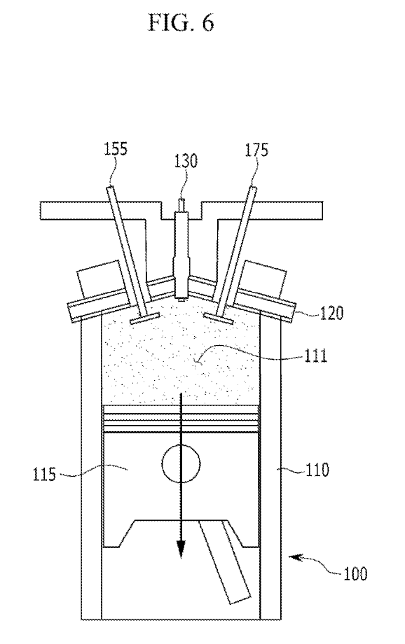

The cylinder 100 includes a cylinder body no in which a combustion chamber in (see FIGS. 6 to 9) generating power by combustion of diesel fuel is formed, and a cylinder head 120 covering an upper portion of the cylinder body 110.

The cylinder body no is formed in a substantially cylindrical shape, and the combustion chamber is formed therein and the upper portion thereof is opened. The cylinder head 120 covers the opened upper portion of the cylinder body 110. That is, the combustion chamber is a space formed by an upper portion of a piston and a lower portion of the cylinder head.

A diesel injector 130 that injects the diesel fuel into the combustion chamber 111 is installed in the cylinder 100.

Hereinafter, a structure of a cylinder according to an exemplary embodiment of the present invention will be described in detail.

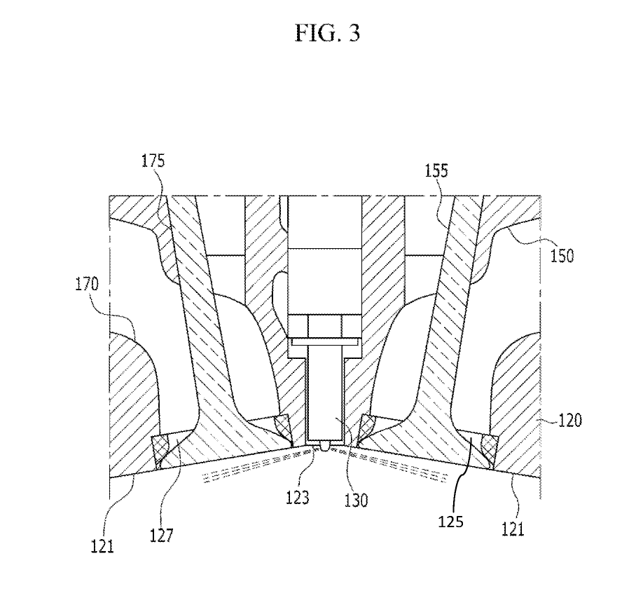

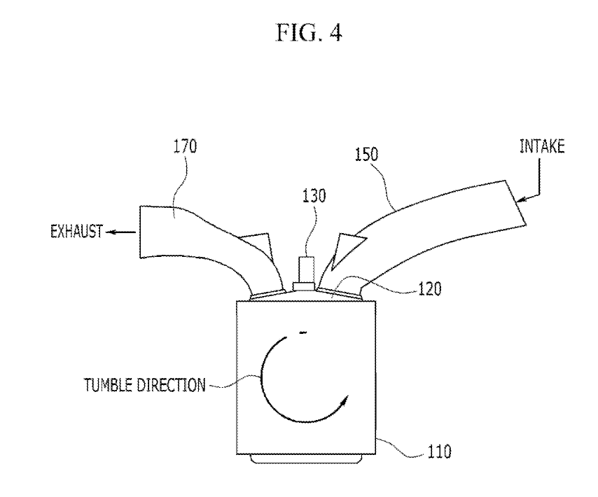

FIG. 3 is a partial cross-sectional view illustrating the cylinder of the diesel engine according to an exemplary embodiment of the present invention.

Referring to FIGS. 2 and 3, the cylinder head 120 is formed in a substantially disk shape to cover the upper portion of the cylinder body no. A lower surface of the cylinder head 120 is formed in a pent roof shape.

To this end, the lower surface of the cylinder head 120 includes a pair of inclined portions 121, and a corner portion 123 which is in contact with the pair of inclined portions 121. The lower surface of the cylinder head 120 forms the pent roof shape by the pair of inclined portions 121 and the corner portion 123 that cooperate with each other.

A pair of intake ports 125 are formed on one side of the pair of inclined portions 121, and a pair of exhaust ports 127 are formed on the other side of the pair of inclined portions 121. That is, the pair of intake ports 125 and the pair of exhaust ports 127 may be formed at positions which are symmetrical with each other with respect to the corner portion 123.

A diesel injector 130 that injects diesel fuel into the combustion chamber is disposed at the center of the cylinder head 120, specifically, at the center of the corner portion 123.

The intake port 125 is connected with an intake pipe 150 for supplying new gas through the intake manifold 10. The exhaust port 127 is connected with an exhaust pipe 170 for discharging exhaust gas generated from the combustion chamber. The exhaust gas generated from the combustion chamber passes through the exhaust port 127 and the exhaust pipe 170 and is discharged to the outside through the exhaust manifold 20.

The intake pipe 150 is mounted with an intake valve 155 that selectively opens and closes the intake port 125. The exhaust pipe is mounted with an exhaust valve 175 that selectively opens and closes the exhaust port 127.

That is, the intake valve 155 and the exhaust valve 175 are provided to be inclined at a predetermined angle in a radial direction outwardly from the center of the cylinder head 120, such that the intake valve 155 and the exhaust valve 175 form a narrow angle with each other.

In other words, the intake valve 155 and the exhaust valve 175 are installed on the inclined portion 121 configuring the lower surface of the cylinder head 120, such that the intake valve 155 and the exhaust valve 175 may be provided to form the narrow angle with each other.

As such, the intake valve 155 and the exhaust valve 175 are provided to form the narrow angle with each other, thereby making it possible to form a diameter of the intake valve 155 to be large. In a case in which the diameter of the intake valve is increased, since an amount of air introduced into the cylinder is increased, performance of the engine is also maximized.

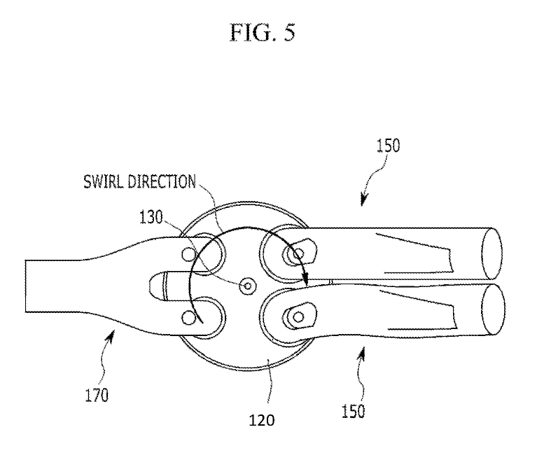

In addition, since the intake valve 155 is installed on the inclined portion 121 of the cylinder head 120 so that the intake valve 155 and the exhaust valve 175 form the narrow angle, a flow in a swirl direction (see FIG. 5) and a flow in a tumble direction (see FIG. ₄) are generated in the cylinder by the air introduced through the intake port 125. As such, since the flow in the swirl direction and the flow in the tumble direction are generated together in the cylinder, the air and the fuel may be smoothly mixed in the cylinder, thereby improving performance of the engine.

Further, during a low temperature combustion of the engine, a combustion chamber space inside the cylinder may be increased due to a space formed in the lower surface of the cylinder head 120 formed in the pent roof shape. Thereby, a compression ratio may be reduced and fuel efficiency of a vehicle may be improved.

Hereinafter, an operation of a diesel engine according to an exemplary embodiment of the present invention will be described in detail with reference to the accompanying drawings.

FIGS. 6 to 9 are views illustrating an operation of a diesel combustion engine according to an exemplary embodiment of the present invention.

Referring to FIG. 6, during an intake stroke, the intake valve 155 included in the intake pipe 150 opens the intake port 125 and the air introduced through the intake manifold 10 is injected into the combustion chamber. Here, according to the present invention, since the diameter of the intake valve 155 may be formed to be large, the amount of air introduced into the cylinder is increased, thereby improving performance of the engine.

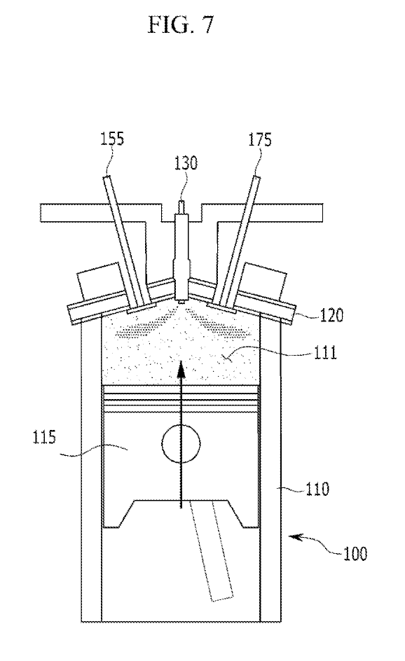

Referring to FIG. 7, during a compression stroke, while the piston 115 moves upwardly, the introduced air is compressed in a high temperature and high pressure state, and when the piston 115 moves to the vicinity of a top dead point, the diesel fuel is injected through the diesel injector 130.

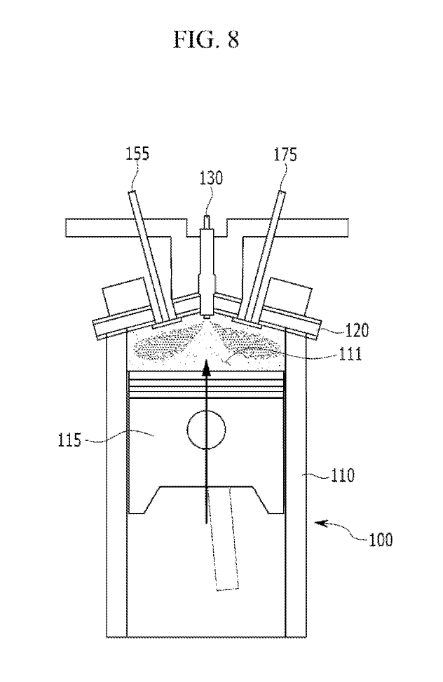

Referring to FIG. 8, during an explosion stroke, the diesel fuel is ignited by a self-ignition and the diesel fuel is combusted. In this case, due to the generated power, the piston 115 generates downwardly power.

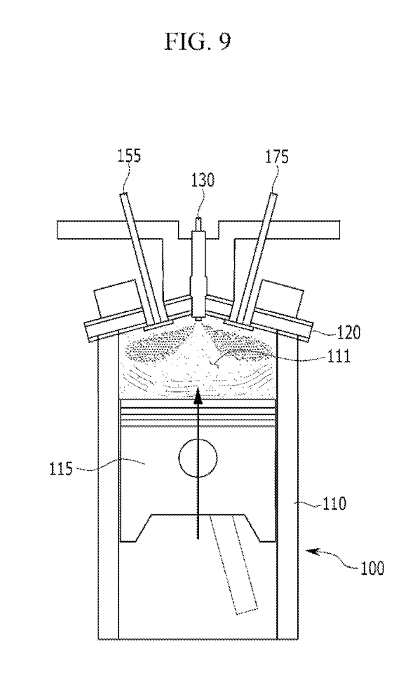

Finally, referring to FIG. 9, during an exhaust stroke, while the piston 115 moves upwardly, the exhaust valve 175 is opened, and the exhaust gas generated during the combustion operation is discharged to the outside through the exhaust poll 127 and the exhaust manifold 20.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A cylinder structure of a diesel engine, comprising:
a cylinder including a cylinder body and a cylinder head covering an upper portion of the cylinder body, wherein a combustion chamber is formed, at least in part, by an upper portion of a piston and a lower portion of the cylinder head; and
an intake valve and an exhaust valve each inclined at a predetermined angle in a radial direction that extends outwardly from a center of the cylinder head, such that the intake valve and the exhaust valve form a narrow angle with each other.

2. The cylinder structure of a diesel engine of claim 1, wherein the intake valve is disposed in an intake port formed in the cylinder head;
wherein the exhaust valve is included in an exhaust port formed in the cylinder head; and
wherein the cylinder has a diesel injector configured to inject diesel fuel into the combustion chamber and that is disposed near the center of the cylinder head.

3. The cylinder structure of a diesel engine of claim 2, wherein a lower surface of the cylinder head has a pent roof shape.

4. The cylinder structure of a diesel engine of claim 3, wherein the lower surface of the cylinder head comprises:
a pair of inclined portions in which each of the intake port and the exhaust port are disposed; and
a corner portion which is in contact with the pair of inclined portions; and
wherein the pent roof shape is formed by the combination of the pair of inclined portions and the corner portion.

5. The cylinder structure of a diesel engine of claim 4, wherein the diesel injector is disposed near the center of the corner portion.

6. The cylinder structure of a diesel engine of claim 4, wherein the intake port and the exhaust port are each disposed in a respective inclined portion of the pair of inclined portions.

7. A diesel engine, comprising:
a cylinder comprising a cylinder body and a cylinder head covering an upper portion of the cylinder body, wherein a combustion chamber is formed, at least in part, by an upper portion of a piston and a lower portion of the cylinder head;
an intake valve disposed in an intake port; and
an exhaust valve disposed in an exhaust port;
wherein the intake port and the exhaust port are each disposed in a portion of a lower surface of the cylinder head that is inclined at a predetermined angle and in a radial direction that extends outwardly from a center of the cylinder head.

8. The diesel engine of claim 7, further comprising a diesel injector configured to inject diesel fuel into the combustion chamber is disposed near the center of the cylinder head.

9. The diesel engine of claim 8, wherein a lower surface of the cylinder head has a pent roof shape.

10. The diesel engine of claim 9, wherein the lower surface of the cylinder head comprises:
a pair of inclined portions in which each of the intake port and the exhaust port are disposed; and
a corner portion which is in contact with the pair of inclined portions; and
wherein the pent roof shape is formed by the combination of the pair of inclined portions and the corner portion.

11. The diesel engine of claim 10, wherein the diesel injector is disposed near the center of the corner portion.

12. The cylinder structure of a diesel engine of claim 10, wherein the intake port and the exhaust port are each disposed in a respective inclined portion of the pair of inclined portions.

13. A diesel engine, comprising:
a cylinder comprising a cylinder body and a cylinder head covering an upper portion of the cylinder body, wherein a combustion chamber is formed, at least in part, by an upper portion of a piston and a lower portion of the cylinder head;
a pair intake valves, wherein each intake valve of the pair of intake valves is disposed in a respective intake port of a pair of intake ports; and
a pair of exhaust valves, wherein each exhaust valve of the pair of exhaust valves is disposed in a respective exhaust port of a pair of exhaust ports;
wherein the pair of intake ports and the pair of exhaust ports are each disposed in a respective inclined portion of a pair of inclined portions of a lower surface of the cylinder head, wherein each inclined portion of the pair of inclined portions is inclined at a predetermined angle and in a radial direction that extends outwardly from a center of the cylinder head; and
wherein the pair of intake ports are disposed at intake port positions which are symmetrical, with respect to the center of the cylinder head, to exhaust portion positions at which the pair of exhaust ports are disposed.

14. The diesel engine of claim 13, further comprising a diesel injector configured to inject diesel fuel into the combustion chamber is disposed near the center of the cylinder head.

15. The diesel engine of claim 14, wherein the lower surface of the cylinder head has a pent roof shape.

16. The diesel engine of claim 15, wherein the lower surface of the cylinder head has a corner portion which is in contact with the pair of inclined portions; and
wherein the pent roof shape is formed by the combination of the inclined portions and the corner portion.

17. The diesel engine of claim 16, wherein the diesel injector is disposed near the center of the corner portion.

18. The diesel engine of claim 13, wherein the pair of intake ports and the pair of exhaust ports are angled toward each other.

19. The diesel engine of claim 13, further comprising an exhaust manifold disposed inline with the pair of exhaust ports; and
an intake manifold disposed inline with the pair of intake ports.
